(19) United States
(12) Patent Application Publication
(10) Pub. No.: US 2021/0336245 A1
(43) Pub. Date: Oct. 28, 2021

(54) POROUS MATERIALS FOR BATTERY ELECTRODES

(71) Applicant: FORM ENERGY, INC., Somerville, MA (US)

(72) Inventors: Michael Andrew GIBSON, Philadelphia, PA (US); Annelise Christine THOMPSON, Medford, MA (US); William Henry WOODFORD, Cambridge, MA (US); Yet-Ming CHIANG, Weston, MA (US)

(21) Appl. No.: 17/236,677

(22) Filed: Apr. 21, 2021

Related U.S. Application Data
(60) Provisional application No. 63/013,864, filed on Apr. 22, 2020.

(51) Int. Cl. H01M 4/133; H01M 4/80

(52) U.S. Cl. CPC H01M 4/133; H01M 2004/021; H01M 4/80

(57) ABSTRACT

Systems and methods of the various embodiments may provide porous materials for electrodes of electrochemical energy storage systems.

### RELATED APPLICATIONS

This application claim priority to U.S. Provisional Application No. 63/013,864 filed Apr. 22, 2020 entitled “Porous Materials For Battery Electrodes”, the entire contents of which are incorporated herein by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, at least ≥8 h) energy storage systems.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Systems and methods of the various embodiments may provide porous materials for electrodes of electrochemical energy storage systems.

Various embodiments may include a battery, comprising: a positive electrode; an electrolyte; and a negative electrode, wherein the negative electrode comprises a porous metal. In various embodiments, the porous metal may be fabricated at least in part using at least one fugitive pore former. In various embodiments, the porous metal comprises iron. In various embodiments, the fugitive pore former is a reducing agent. In various embodiments, the reducing agent comprises carbon. In various embodiments, the fugitive pore former comprises iron (II) sulfate, iron (II,II) sulfate, mackinawite, marcasite, pyrite, troilite, pyrrhotite, greigite, amorphous iron (II) sulfide, or lead sulfide. In various embodiments, the fugitive pore former comprises coal. In various embodiments, the porous metal is produced by reduction in a hearth furnace. In various embodiments, the hearth furnace is a rotary hearth furnace or a linear hearth furnace. In various embodiments, the porous metal is produced by reduction in a rotary kiln.

In various embodiments, formation of pores in the porous metal occurs by electrochemical reduction in the battery. In various embodiments, the fugitive pore former comprises silica, sodium silicate, sodium oxide, calcium oxide, or magnesium oxide. In various embodiments, the fugitive pore former comprises a salt of the electrolyte. In various embodiments, the fugitive pore former comprises potassium or sodium hydroxide. In various embodiments, the fugitive pore former comprises ammonium nitrate or potassium sulfate. In various embodiments, wherein the porous metal is formed from a precursor material having a first size and the fugitive pore former particle size is about the same as the first size. In various embodiments, the porous metal has a layer of discharge product on its surface and the fugitive pore former particle size exceeds twice a thickness of the layer of discharge product. In various embodiments, at least one fugitive pore former comprises at least two different fugitive pore formers. In various embodiments, the two different fugitive pore formers are different type pore formers and/or different size pore formers. In various embodiments, further comprising a current collector metallurgically bonded and/or in electrical communication with the negative electrode, the current collector along at least a portion of the negative electrode. In various embodiments, the positive electrode comprises an air-breathing cathode, a nickel oxyhydroxide electrode, or a manganese dioxide electrode. In various embodiments, the iron comprises steelmaking dust, mill scale, iron ore, iron mesh, iron wire, iron powder, or any combination thereof. In various embodiments, the fugitive pore former comprises coke. In various embodiments, the porous metal may be fabricated at least in part using a pore former comprising a metal carbonate. Various embodiments may include methods of forming a porous metal for a negative electrode of a battery, comprising using at least one fugitive pore former to form pores in the porous metal. In various embodiments, the pores of the fugitive pore former may be formed with a reduction step or without a reduction step.

### DESCRIPTION OF THE DRAWINGS

FIG. 1 is a schematic of a portion of an electrochemical cell according to various embodiments.

FIG. 2 is a process flow diagram illustrating a method of forming a porous metal for a negative electrode.

FIGS. 3-11 illustrate various example systems in which one or more aspects of the various embodiments may be used as part of bulk energy storage systems.

### DETAILED DESCRIPTION

References made to particular examples and implementations are for illustrative purposes and are not intended to limit the scope of the claims. The following description of the embodiments of the invention is not intended to limit the invention to these embodiments but rather to enable a person skilled in the art to make and use this invention.

The following examples are provided to illustrate various embodiments of the present systems and methods of the present inventions. These examples are for illustrative purposes, may be prophetic, and should not be viewed as limiting, and do not otherwise limit the scope of the present inventions.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

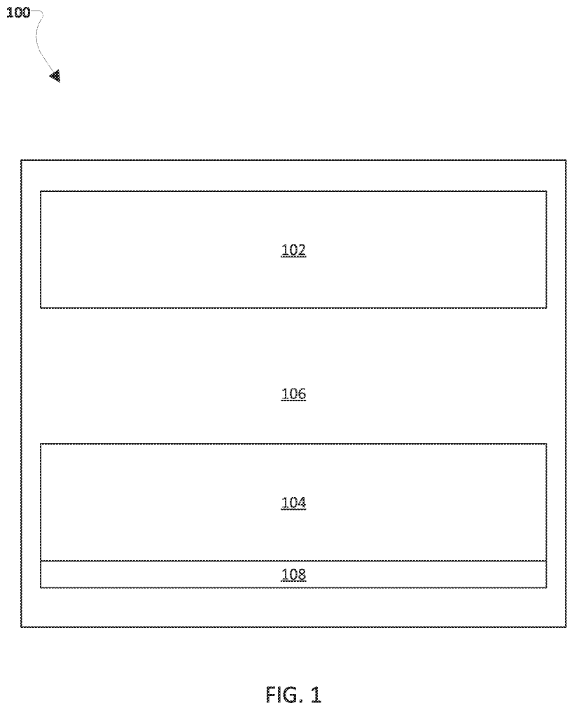

FIG. 1 is a schematic of portions of an electrochemical cell, such as a battery 100, according to various embodiments. The battery 100 may include a positive electrode 102, an electrolyte 106, and a negative electrode 104. In various embodiments, the negative electrode 104 may integrate a current collector 108. As specific examples, the battery 100, positive electrode 102, electrolyte 106, the negative electrode 104, and/or current collector 108 may be any battery, positive electrode, electrolyte, negative electrode, and/or current collector described in U.S. Patent Application Publication No. 2020/0036002, U.S. Patent Application Publication No. 2021/0028452, and/or U.S. Patent Application Publication No. 2021/0028457, the entire contents of all three of which are hereby incorporated by reference for all purposes. One or more batteries 100 may be connected together in an energy storage system, such as a long-duration energy storage system, an ultra-long-duration energy storage system, etc.

In various embodiments, the electrolyte 106 may be any electrolyte known in the art, such as any electrolyte useful for iron alkaline batteries. In various embodiments, the negative electrode 104 may be formed from and/or include a porous metal, such as porous iron. In various embodiments, the negative electrode 104 may be an alkaline electrode, such as an alkaline iron electrode.

The current collector 108 may be a mesh or other porous surface integrated into the material used in a process uses to form the negative electrode 104, such as a reduction process described herein. The current collector 108 may be an iron plate. The current collector 108 may be metallurgical bonded or placed in electrical communication with the electrode 104 via mechanical pressure. The electrode 104 may be so conductive that it does not need current collection along its entire length, but rather solely requires current collection on tabs at the electrode's 104 top. Alternatively, the electrode 104 may be so porous that its conductivity becomes quite poor and current collection is needed along the entire electrode area.

The positive electrode 102 may also be referred to as a counter electrode, and the counter electrodes for such an anode (or positive electrode 102) may be any counter electrodes known in the art, such as any counter electrodes for alkaline iron batteries, including, but not limited to, air-breathing cathodes, nickel oxyhydroxide electrodes, and manganese dioxide electrodes.

Given the large volume change between the charge and discharge products produced during the electrochemical cycling of an alkaline iron electrode, such as negative electrode 104, porosity may be a key metric determining the capacity obtainable from an iron electrode. Methods of achieving high-porosity, low-cost iron electrodes are therefore of interest for achieving high performance, low cost iron batteries.

Without being limited to any specific theory or model of the reactivity of the iron electrode, such as negative electrode 104, possible schemes for the oxidation of the iron electrode, such as negative electrode 104, in alkaline electrolyte, such as electrolyte 106, can proceed according to the following two reaction steps, Reaction 1 and Reaction 2 shown below in Table 1. Additional or different reaction products are possible (one of which is described in Reaction 3 below in Table 1), but the characteristic of volume change through the reaction is general to any oxidation product relative to metallic iron.

TABLE 1

| | | |
|---|---|---|
| Reaction 1: | Fe + 2OH⁻ → | E⁰ = −0.88 V vs. SHE |
| | Fe(OH)₂ + 2e⁻ | |
| Reaction 2: | 3Fe(OH)₂ + 2OH⁻ → | E⁰ = −0.76 V vs. SHE |
| | Fe₃O₄ + 4H₂O + 2e⁻ | |
| Reaction 3: | Fe(OH)₂ + OH⁻ → | E⁰ = −0.61 V vs. SHE |
| | FeOOH + H₂O + e⁻ | |

Table 2 gives some key physical properties of selected charge and discharge products in the alkaline iron electrode, such as negative electrode 104.

TABLE 2

| Characteristic | Fe | Fe(OH)₂ | Fe₃O₄ |
|---|---|---|---|
| Molar mass (g/mol) | 55.9 | 89.9 | 231.5 |
| Density (g/cc) | 7.87 | 3.40 | 5.17 |
| Molar volume (cc/mol) | 7.1 | 26.4 | 44.8 |
| Volume per mol Fe (cc/mol) | 7.09 | 26.43 | 14.93 |
| Pilling-Bedworth Ratio | — | 3.73 | 2.10 |
| Theoretical Specific | — | 959.76 | 1279.68 |
| Capacity-Direct (mAh/g_{Fe}) | | | |
| Theoretical Specific Capacity- | — | 959.76 | 319.92 |
| Marginal (mAh/g_{Fe}) | | | |

The Pilling—Bedworth ratio is the ratio of the volume of the elementary cell of a metal oxide to the volume of the elementary cell of the corresponding metal (from which the oxide is created) and is a measure of the net volume change in one step of the reaction.

Iron-based materials exhibiting enhanced porosity may be fabricated by use of particulate materials processing techniques. One technique of introducing porosity during particulate materials processing is to introduce a fugitive phase. In one aspect, iron materials produced using a rotary or linear hearth process (RHF or LHF, respectively) commonly use coal-based reductants, which also act as fugitive pore formers. Materials produced according to these processes may have advantageous properties when used in an iron electrode for a storage battery (a battery may also be referred to herein as an electrochemical cell), such as a negative electrode 104. Other methods of introducing fugitive phases and forming iron-based materials via low-cost reduction techniques are also described. In some cases, the iron-based material may be reduced electrochemically inside the battery assembly (e.g., battery 100), rather than thermochemically reduced during a processing step before introduction into the battery (e.g., battery 100). In various embodiments, the iron electrode of a battery (or electrochemical cell), such as battery 100, may be the negative electrode of the battery (or electrochemical cell), such as negative electrode 104.

Various embodiments may relate to the geometry of the input material to the reduction process and ways of creating the geometry. Iron-based materials for alkaline batteries, such as battery 100, may take a variety of forms, some of which are described below along with advantages and disadvantages appropriate to the various forms.

Iron-based materials for input into a reduction process may be produced at very low cost from iron precursor pellets. Such iron precursor pellets may, for example, be formed by techniques used in for the manufacture of oxide pellets for blast furnaces and oxide pellets for direct reduction. During the pelletizing process, a fugitive phase may be introduced to the mixture which undergoes agglomeration, thereby providing a homogenous mixture of the fugitive phase with the other constituents within the pellet. Such an approach is useful in that it takes advantage of the large scale and low costs of pelletizing processes used in various industries, such as the steel industry. The pellets produced by such processes are usually roughly spherical and can range in size from several millimeters to several tens of millimeters. The radius of the pellets may be selected to yield desired kinetics for the reduction process, or desired mass and electrical transfer characteristics when used as an electrode in an energy storage device, such as a negative electrode 104 in a battery 100. An example of a fugitive phase being introduced into the mixture used in agglomeration is the introduction of coke into the pellets used in rotary hearth furnaces.

The iron-based material may also be made into sheets rather than pellets. These sheets may be produced by extrusion or doctor blading of iron precursor material into sheets. The mixture used in the sheet production process may contain a fugitive phase. In one example, magnetite ore concentrate mixed with coke may be doctor bladed into a thickness of approximately 5 mm and subsequently reduced in a linear hearth furnace. In another case, the sheet may be cut into strips and subsequently fed onto a rotary hearth furnace. The thickness of the sheet may be selected to yield desired kinetics for the reduction process, or desired mass and electrical transfer characteristics when used as an electrode in an energy storage device, such as negative electrode 104 in battery 100.

Other geometries may be possible for the iron-based material, including rods, discs, or plates. These geometries can in general be formed by techniques for the formation of green bodies in the particulate materials processing art including roll compaction of sheets, pressing and slip casting of plates, and extrusion to create rods and discs. Discs may result from extrusion when a circular die is used and the resulting material is cut to shape after exiting the die, from die compaction, or from slip casting into a cylindrical mold.

In some cases, the geometric shape which results from the reduction process may be subsequently broken up into small pieces. In one example, pellets from a direct reduction process possessing diameters on the order of 10 mm (mm=10⁻³ m) may be crushed after the reduction step such that the particle size is substantially refined to a particle size between 1 mm and 6 mm after the crushing process.

Many processes may be utilized for accomplishing the reduction of iron-containing materials to less-oxidized or metallic forms of iron.

In one aspect, the iron-containing materials may be reduced by decomposition of a carbon-containing materials contained within the precursor material or distributed adjacent to the precursor material. This may occur by solid-state reduction with coal, coke, or other carbon-containing materials as occurs in rotary hearth furnaces used for the production of direct reduced iron. In other reduction processes involving carbon-containing materials, the carbon-containing material is distributed adjacent to the iron-containing material and reduction occurs via gas-phase transfer of reducing species from the carbon-containing material to the iron-containing material. For example, coal may be thermally decomposed in the presence of oxygen to yield a variety of reducing species including methane, hydrogen, and carbon monoxide. Any of the processes used in rotary kiln reduction processes or rotary hearth reduction processes should be considered applicable to the reduction of the iron-containing materials, including coal gasification wherein the coal is not strictly next to the iron-containing materials but is still used as a reductant.

Iron-containing materials may also be reduced via reaction with gas-phase reductants. There are many ways of introducing such reducing gases. One may split out these many ways of performing the reduction with gaseous constituents according to the machinery used to create the reducing process (and into sub-categories of batch and continuous processes). The processes may also be thought of in terms of the atmospheres which they use. A non-exhaustive list of the machinery used to create the reducing atmosphere and the types of reducing gases which may be used is include: 1) various machinery for introducing reducing gases, such as batch processes (e.g., using box furnaces, using tube furnaces, using vacuum furnaces, or using any other type of batch process furnace) and/or continuous processes (e.g., using linear horizontal furnaces, such as walking beam furnaces, linear hearth furnaces, belt furnaces, kiln furnaces, calcining-type furnaces, etc., using vertical shaft furnaces, using fluidized bed reactors, using grated furnaces, such as traveling grate furnaces where reducing gases are introduced, etc., or using any other type of continuous process furnace); and/or 2) various types of reducing atmospheres, such as carbon monoxide, hydrogen, methane, hydrogen sulfide, nitrogen, argon, dissociated ammonia, and/or combinations of the same, the reducing atmospheres produced in various manners including by electrolysis, natural gas, reactions of natural gas with water (including the use of syngas and water gas shifted syngas), etc.

Despite the great variety of such processes, the commonalities between all of them is that the processes generally require temperatures above at least 400° C. (usually substantially higher) and a continuous refreshing of the gas atmosphere in order to attain reasonable reduction kinetics and reasonable completion of the reduction reaction. The amount of time needed will in general depend on many factors (including the starting material, desired final reduced state, particle size, powdered body thickness, etc.), but typical conditions range from 700° C. to 1450° C. and 15 minutes to 3 hours at peak temperature.

In another aspect, the iron-containing materials may be electrochemically reduced. This may occur in an alkaline electrolyte, often with a pH above 12. Current collection and conductors through the pore space may be provided to allow the electrochemical process to occur successfully. Reduction outside of alkaline media may also be performed. The reduction may occur inside the same electrochemical cell that is used for electrochemical energy storage, such as inside the battery 100.

Various embodiments may include using fugitive phase pore formers to form pores in an electrode, such as the negative electrode 104. A fugitive phase may be used to create pore space (i.e., act as a pore former) inside a powdered compact. The essential requirement of a fugitive phase which acts as a pore former is to hold a volume open inside a powdered body until a point in the processing of the powdered body the powdered body attains sufficient mechanical integrity that the pore former may be removed and some of the volume left by the pore former remains as a pore. That is, a pore former may be used to increase the porosity of the material into which it is added. As different powdered bodies attain sufficient mechanical integrity at various points during processing, the means by which one introduces pore formers and the means by which one removes the pore former from the powdered body may be a function of the processing applied to the powdered body. In what follows, several methods of introducing pore formers are introduced. First, the pore formers themselves are introduced based on when/how they enter and leave the powdered compact. Subsequently, geometric characteristics of the pore formers are described within the context of their application to the production of iron-containing electrodes for energy storage.

Various embodiments may include using one or more materials as pore formers. In general, the reduction of iron containing materials described previously may take place by either high temperature thermochemical reduction, or by lower temperature electrochemical reduction.

First, fugitive phase pore formers for high temperature reduction processes are described. There are at least three ways that one can introduce pores via a pore former into a material produced by high temperature processing: 1) to remove the pore former prior to high temperature processing; 2) to remove the pore former during high temperature processing; and/or 3) to remove the pore former after high temperature processing. Functional characteristics and examples of each are described below.

In order to remove a pore former from a powdered body before high temperature processing, a pore former may be first introduced to the body, the body may be allowed to attain some strength, and then the pore former may be removed. In one example of this, a pore former may be introduced into the body that contains a binder material (often a water-soluble binding agent which sets when dried from water). After the binding material is allowed to set or otherwise strengthen the material, the powdered body may be processed in such a manner that the pore former is removed. To give a concrete example, a pore former may be any material soluble in an organic solvent (i.e. paraffin wax in hexane), the porous body may be iron ore using a cement (for example, bentonite, sodium carbonate, calcium chloride, or sodium silicate) as a binder, and after the pellet has dried, the pore former may be dissolved by exposing the porous body to the organic solvent which dissolves the pore former while not altering the binder. In a second example, an iron ore porous body may use cement as a binder, and the binder, upon drying, may set and become insoluble in water. As such, a pore former that dissolves in water (for example, sodium chloride or any other water-soluble salt) may be removed from the pellet by re-exposure of the pellet to water. The pore former may also be a metal carbonate such as sodium carbonate or calcium carbonate (e.g., ground limestone), which dissolve in mild acidic solutions leaving pores. In a final example, a solid pore forming material may be added to the porous body which is inert during the process of forming the porous body but is easily evaporated during subsequent processing. For example, ammonium bicarbonate may be added to a compacted magnetite ore body, the compaction being sufficient to impart sufficient mechanical integrity to the porous body that the ammonium bicarbonate may be removed from the porous body via evaporation while some of the volume previously occupied by the ammonium bicarbonate is retained as pores. This evaporation may occur at low temperatures (˜36-41° C.) and may be accomplished prior to high temperature processing.

Materials may also be added which are removed during the high temperature processing steps. There are two such steps which often occur during the processing of iron-containing precursor materials. The first step is a preprocessing step which occurs prior to many reduction processes and after the formation of blast furnace and direct reduction pellets termed induration. During this process, pellets or other powdered bodies are oxidized at high temperatures. Through this oxidation process, the materials also gain mechanical integrity. Coke or other materials which evaporate in the presence of high temperatures may be added to powdered bodies in order to act as fugitive pore formers. Polymers, wood fiber, and carbonaceous materials produced by torrefaction may all be added as a means of inducing porosity during induration. It should be noted that not all materials need to be indurated prior to reduction, and thus that this step is not strictly necessary in the processing path.

During the high temperature reduction process, the powdered body is exposed to gases, usually carbon monoxide and hydrogen, which reduce the iron-containing materials. Materials that have a propensity to dramatically change volume upon exposure to such atmospheres may be added to iron-containing powdered bodies as a means of enhancing the porosity of the resulting materials. For example, iron sulfides and sulfates are not traditionally included in iron precursor material mixtures as inputs to reduction processes. However, in the specific case of iron alkaline electrodes these iron-sulfur compounds can serve multiple useful purposes. First, sulfur has been shown to be a useful compound in iron electrodes for promoting higher discharge capacities. Second, the iron sulfides and sulfates have very high ratios of the molar volume of the compound to the molar volume of the iron formed upon decomposition. Thus, these iron-sulfur compounds may act as pore formers upon loss of sulfur and oxygen due to these large reductions in volume. An especially inexpensive and effective pore former in this regard is iron (II) sulfate, which has a ratio of the volume of the sulfate to the volume of the iron upon reduction of 5.9-to-1 in the anhydrous state, with even larger volume ratios observed for the hydrated compound. Iron (II) sulfate is a byproduct of the steelmaking pickling process and may be usefully recycled in this manner to introduce a pore forming agent which introduces residual iron and sulfur as byproducts of the pore formation process. Other sulfides and sulfates of iron may be similarly used as fugitive phases which deposit iron and sulfur including, but not limited to, iron (II,II) sulfate, mackinawite, marcasite, pyrite, troilite, pyrrhotite, greigite, and amorphous iron (II) sulfide.

Given that some materials may undergo useful phase transformations upon exposure to oxygen and subsequent reduction, other compounds may be usefully introduced to iron-containing materials which undergo induration and subsequent reduction. In one aspect, lead sulfide may be ground into a fine particulate and introduced as part of the iron-containing material mixture prior to an induration process. During the induration process, the lead sulfide may be roasted to form lead oxide. It should be noted that the melting point and boiling point of lead sulfide are both low relative to typical induration temperatures for iron oxide pellets. In order to retain the lead in the pellets, the induration procedure may need to be run at temperatures substantially below the boiling point of the lead sulfide (generally at least 20° C.), and preferably even below the melting point of the lead sulfide. Higher oxygen concentrations and longer times at temperature may be needed to achieve the same degree of induration when compared to higher temperature induration processes. The degree to which the liquid lead affects microstructural development will in general be a function of the various constituents in the iron pellets.

The lead oxide may be subsequently reduced to form lead metal distributed homogeneously with the pore space of the iron body. Lead is a known inhibitor of the hydrogen evolution reaction which competes with the charging processes for iron electrodes. Thus, inclusion of lead sulfide in an iron-containing precursor material may lead to the simultaneous formation of a pore and inclusion of a useful compound in the resulting battery electrode.

Materials may act as pore formers in the iron-containing material after the reduction process by dissolution. A limited set of materials are stable after reduction at temperatures that often exceed 700° C. in hydrogen. In one embodiment, silica may be included which may dissolve in the alkaline electrolyte. In another embodiment, sodium silicate (also known as water glass) may dissolve in an aqueous solution after the reduction process. In other embodiments, silicates such as quartz, feldspar, mica, amphibole, pyroxene, or olivine may be incorporated as soluble fugitive pore formers. Basic oxides which are stable through the reduction processes, such as sodium oxide, calcium oxide, or magnesium oxide, may be easily etched out of the iron skeleton via an acid after the reduction process (although such oxides may also dissolve in alkaline solution). In some embodiments, the basic oxide may be first added as a metal salt such as a sulfate, a carbonate, or a hydroxide, whereupon thermal decomposition to the oxide provides a first reduction in volume that increases the porosity. Optionally, the basic oxide may subsequently be removed by dissolution for a further increase in porosity. As an example, calcium carbonate in the form of limestone, or dolomite (calcium-magnesium carbonate), or calcium hydroxide or magnesium hydroxide, will each thermally decompose at temperatures in the range of 500-1100 degrees centigrade leaving their respective oxides.

Finally, for electrodes wherein the reduction is to happen electrochemically, pore formers may be chosen such that they dissolve in the electrolyte. In one aspect, the pore former may be a salt which is a component of the electrolyte. By way of illustration, a component of an alkaline electrolyte for iron batteries may be potassium or sodium hydroxide. A pore former made from potassium hydroxide may save costs by acting as both electrolyte additive and a pore former. In another aspect, the pore former may be a substance that is inert during electrochemical processing, such as ammonium nitrate or potassium sulfate.

In certain embodiments, the fugitive pore former may be the reducing agent in the conversion of iron ore (a more oxidized material) to iron metal. In certain other embodiments, the fugitive pore former may be itself reduced in the reduction step. In certain other embodiments, multiple pore formers, including combinations and variations of pore formers, serving as reducing agents or not participating in the reduction reactions may be used.

The geometric relationship between the pore former and the other elements of the microstructure play an important role in determining the optimal pore former size and volume fraction. Two general regimes may be distinguished. In one regime, the performance of the battery is limited by the amount of porosity immediately surrounding the iron. In this regime, the optimal pore former particle size is approximately the same as the particle size of the iron precursor particles input into the reduction process. In this regime, approximately matching the pore former size to the or particle size permits the porosity added through pore former addition to be most homogeneously distributed and with a minimal amount of porosity which is not directly adjacent to a reacting iron surface. Directly adjacent may be defined as being within one average pore radius from an iron surface. In cases where the pore former particles are not approximately equiaxed, the short axis of the pore former is should be approximately matched to the diameter of the iron ore particles.

In a second regime, the performance of the battery is limited by mass transport through the anode due to filling of the pore space. In this regime, the goal of introducing a pore former is to create a pore that is sufficiently large that it will not fill with discharge product such that the pore can act as a highly diffusive pathway through the microstructure. In this regime, the pore former should have a particle size exceeding twice the thickness of the layer of the discharge product that can be observed on the surface of the reacted iron surface. In this manner, the pores should be able to stay open after formation of the discharge product and facilitate mass transport through the electrode. In cases where the pore former is not approximately equiaxed, the short axis of the pore former should obey the guidance of being at least twice the thickness of the layer of the discharge product. In cases where one desires to create diffusive paths through the porous body which will not clog, the aspect ratio of the pore former will lead to different percolation thresholds of the residual porosity at different aspect ratios. High aspect ratio rods will percolate at the lowest volume fraction in randomly assembled porous bodies, potentially permitting the highest gain in diffusive kinetics at the lowest volume fraction of pore former (and therefore the lowest added cost. In general for the second regime, there is likely to be diminishing returns to performance in pore former additions above approximately 30-35 vol. % of pore former (where the pore former volume fraction is expressed as a percentage of the solids added to the porous body) due to the high porosities attained after reduction and the high likelihood of percolation of the resultant porosity. Nonetheless, in related electrode systems, a higher volume fraction of pore formers has been demonstrated to exert some benefit on battery performance as quantified by an increase in the discharge capacity of the battery. The pore former volume fraction may in some embodiments be up to 45 vol. % while still having benefits for increased anode capacity. While high pore former volume fractions are generally beneficial for some aspects of battery performance, bounds may be placed on the volume fraction of the pore former according to where reasonable increases in performance are observed, and in some instances where the pore-forming agent is effective as a reducing agent during a reducing process. In many circumstances, at least 5 vol. % of the pore former is needed in order to gain substantial increases in battery performance and to realize sufficient gains in performance. In the case of coke added to magnetite ores, one may instead use a weight percentage basis to quantify the amount of pore forming additive included. In the case of coke added to magnetite ores, a weight percentage of coke between 3 to 10 wt. % is generally sufficient to achieve the desired combination of pore forming and reduction.

Pore formers which are much larger than the limits discussed (e.g., about twice the discharge layer thickness and about the average particle size) are likely to impart less improvements to performance relative to finer pore formers on an equivalent-volume basis. In all cases, as the volume fraction of the pore former increases, mass transport becomes more facile and polarization due to mass transport is reduced, while the effective conductivity of the porous body is reduced, as is the volumetric energy density of the electrode. The optimal amount of pore former can be guided via impedance measurements and measurements of the dominant source of impedance in the system and considerations around the required energy density of the system. There is a tradeoff around porosity in that increasing porosity will improve ion transport (kinetics) but will decrease the energy density per unit volume; this tradeoff implies that for a given rate, there will be an optimal porosity to maximize energy density.

In general, adding pore formers much finer than to particle size of the input iron-containing materials is unlikely to result in a substantial increase in porosity, although it may result in other positive process characteristics (e.g., more effective reduction and faster reduction kinetics in rotary heart reduction processes).

In some electrode configurations, combinations of the above effects may be used to produce a superposition of the desired effects. For example, a fine, equiaxed pore former on the order of the particle size may be added to increase the accessible volume for the formation of discharge product and a larger, high aspect ratio fiber-like pore former may be added to enhance mass transport through the porous body.

In general, pore forming agents may be usefully combined when their various roles are complementary. In one illustrative example, coke may be added to perform a solid state reduction process of iron-containing precursors, but too much added coke may result in undesirably high carbon contents after the reduction process. In circumstances where a higher amount of pore former is desired than can be added without resulting in undesirably high carbon contents, a second pore forming additive may be added in addition to the coke to supply a pore forming function without adding additional carbon, while the coke level is maintained at a level sufficient to accomplish the desired reduction reaction.

The sources for iron-containing materials using in various embodiments may be any of the materials commonly used in either iron electrodes or industrial iron reductions processes including, but not limited to the following the examples: 1) steelmaking dust; 2) mill scale (e.g., mill scale may be ground or otherwise processed to attain an appropriate size and shape); 3) iron ores, including ores that have been concentrated and/or beneficiated, for example by float separation or magnetic separation (e.g., iron ores may include Hematite ores, Magnetite ores, Iron-sulfur compounds, etc.); 4) iron mesh and wires embedded in the electrode to serve as a current collector and/or a source of iron; and 5) combinations of one or more of examples 1-4 combined with iron powders, such iron powders including carbonyl iron powders, sponge irons, water atomized powders, etc.

One may also simply use coke as a pore forming fugitive phase in the creation of sintered iron electrodes without a reduction step involved. Coke is one of the lowest cost possible pore formers on a per-volume basis and also will enable much less stringent atmosphere controls during the sintering process due to the protective, reducing environment produced by the coke inside the powdered mass

The particle sizes of the iron precursor materials may be selected based on the particle sizes inherent to upstream processes used to produce the iron ore source, based on the particle size needed to successfully reduce the iron ore source during the appropriate reduction process applied, or based on the resulting iron electrode material achieving sufficient performance during electrochemical cycling. Generally, fine ore particles are desired for both reduction processes and electrochemical performance, with successful particle sizes prior to reduction being below d₉₀<45 microns for magnetite-based ores for battery discharge timescales of around 10 hours. (d_{N} is the particle diameter corresponding to the Nth percentile in a particle size distribution. For example, d₉₀ means the 90th percentile of particle size distribution, or stated differently, that 90% of particles in a given distribution have a size below d₉₀. This could be measured by a dynamic light scattering method, imaging, or other methods known in the art.). Other particle sizes are possible based on the reduction process and electrochemical process applied, with longer reduction times and lower electrochemical charge/discharge rates permitting the use of larger particle sizes. For batteries where much high rate capability is needed, an iron precursor size may be needed, with precursor sizes with a d₅₀ of ˜8 microns being desired. The desire for fineness of the incoming iron precursor materials is generally balanced by cost considerations related to performing more intensive grinding operations.

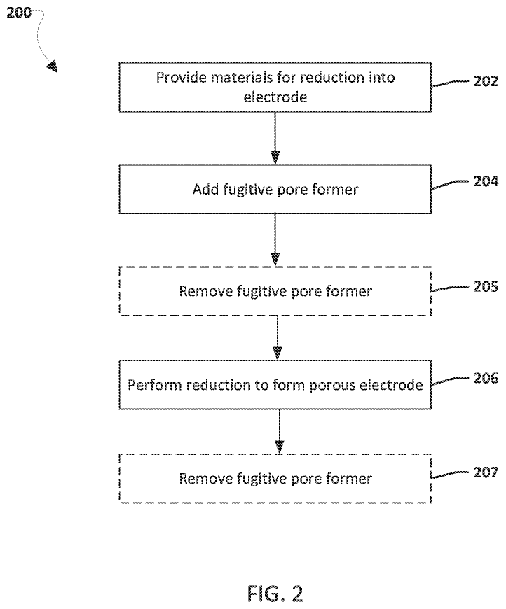

In keeping with the various embodiments discussed above, FIG. 2 illustrates steps of a method 200 according to various embodiments for forming an electrode, such as a negative electrode 104, using one or more fugitive pore formers.

In step 202, materials for reduction into an electrode, such as a negative electrode 104, may be provided. The materials may be materials discussed above, such as metal-based materials, such as iron-based materials. The materials may be precursor materials, such as iron precursor pellets, iron precursor sheets, iron precursor strips, iron precursor discs, iron precursor rods, iron precursor powders, etc. As specific examples, the metals may be steelmaking dust, mill scale, iron ore, iron mesh, iron wire, iron powder, or any combination thereof.

In step 204, one or more fugitive pore former may be added to the materials. In various embodiments, a fugitive pore former may be a reducing agent, such as carbon. In various embodiments, a fugitive pore former be iron (II) sulfate, iron (II,II) sulfate, mackinawite, marcasite, pyrite, troilite, pyrrhotite, greigite, amorphous iron (II) sulfide, or lead sulfide. In various embodiments, a fugitive pore former may be coal. In various embodiments, a fugitive pore former may be silica, sodium silicate, sodium oxide, calcium oxide, or magnesium oxide. In various embodiments, a fugitive pore former may include coke. In various embodiments, a fugitive pore former may include a metal carbonate. In various embodiments, the fugitive pore former may be two or more different fugitive pore formers.

In high temperature reduction processes as discussed above, the addition of the one or more fugitive pore formers in step 204 may occur prior to, or during, reduction by high temperature processes.

In embodiments in which electrochemical reduction of the electrode may occur, the addition of the fugitive pore former in step 204 may occur during electrochemical reduction, such as during reduction in the battery (e.g., 100). For example, the fugitive pore former may be a salt of the electrolyte (e.g., electrolyte 106). When the addition of the fugitive pore former in step 204 may occur during electrochemical reduction the fugitive pore former may be potassium, sodium hydroxide, ammonium nitrate, and/or potassium sulfate.

In some optional embodiments, in optional step 205, at least a portion of the fugitive pore former may be removed prior to reduction in step 206. Accordingly, step 205 may be optional. As discussed above, the fugitive pore former may be dissolved or evaporated prior to reduction.

In step 206, reduction of the porous electrode may occur. The reduction may be via high temperature processing or via lower temperature electrochemical processes, such as electrochemical reduction in the battery (e.g., 100). As discussed above, the reduction process, whether thermal or electrochemical, may result in at least a portion of the one or more fugitive pore formers being removed, thereby forming pores in the resulting electrode. As a specific example, a porous metal electrode may be formed, such as a porous metal electrode including iron.

In some optional embodiments, in optional step 207, at least a portion of the fugitive pore former may be removed following the reduction in step 206. Accordingly, step 207 may be optional. As discussed above, the fugitive pore former may be dissolved by the electrolyte in the battery following reduction, dissolved in an aequeous solution, etched out using an acid bath following reduction, etc.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

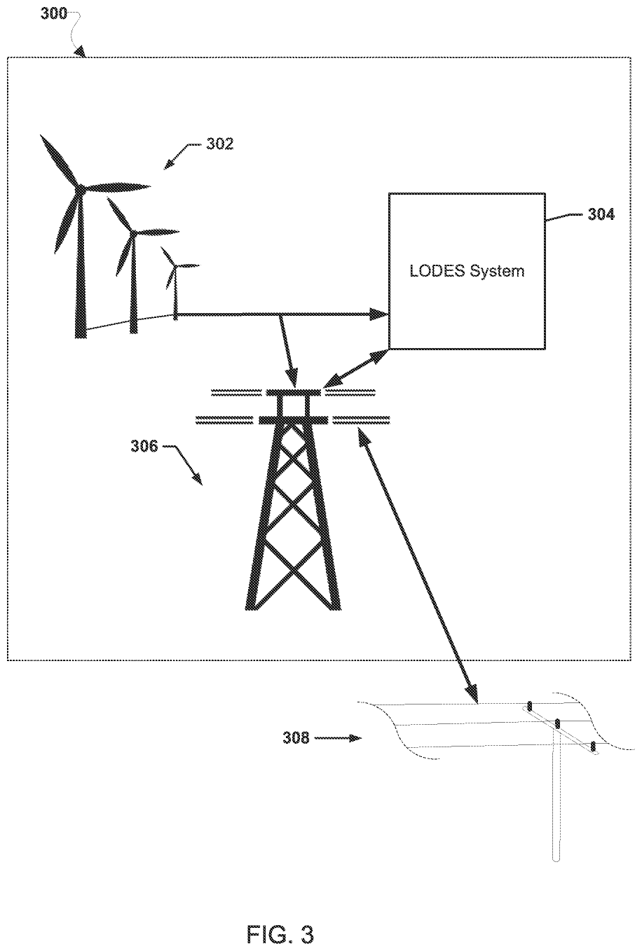

FIGS. 3-11 illustrate various example systems in which one or more aspects of the various embodiments may be used as part of bulk energy storage systems, such as LODES systems, SDES systems, etc. For example, various embodiments described herein with reference to FIGS. 1-2 may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 3 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to the grid 308. The wind farm 302 may generate power and the wind farm 302 may output generated power to the LODES system 304 and/or the transmission facilities 306. The LODES system 304 may store power received from the wind farm 302 and/or the transmission facilities 306. The LODES system 304 may output stored power to the transmission facilities 306. The transmission facilities 306 may output power received from one or both of the wind farm 302 and LODES system 304 to the grid 308 and/or may receive power from the grid 308 and output that power to the LODES system 304. Together the wind farm 302, the LODES system 304, and the transmission facilities 306 may constitute a power plant 300 that may be a combined power generation, transmission, and storage system. The power generated by the wind farm 302 may be directly fed to the grid 308 through the transmission facilities 306, or may be first stored in the LODES system 304. In certain cases the power supplied to the grid 308 may come entirely from the wind farm 302, entirely from the LODES system 304, or from a combination of the wind farm 302 and the LODES system 304. The dispatch of power from the combined wind farm 302 and LODES system 304 power plant 300 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 300, the LODES system 304 may be used to reshape and “firm” the power produced by the wind farm 302. In one such example, the wind farm 302 may have a peak generation output (capacity) of 260 megawatts (MW) and a capacity factor (CF) of 41%. The LODES system 304 may have a power rating (capacity) of 106 MW, a rated duration (energy/power ratio) of 150 hours (h), and an energy rating of 15,900 megawatt hours (MWh). In another such example, the wind farm 302 may have a peak generation output (capacity) of 300 MW and a capacity factor (CF) of 41%. The LODES system 304 may have a power rating of 106 MW, a rated duration (energy/power ratio) of 200 h and an energy rating of 21,200 MWh. In another such example, the wind farm 302 l may have a peak generation output (capacity) of 176 MW and a capacity factor (CF) of 53%. The LODES system 304 may have a power rating (capacity) of 88 MW, a rated duration (energy/power ratio) of 150 h and an energy rating of 13,200 MWh. In another such example, the wind farm 302 may have a peak generation output (capacity) of 277 MW and a capacity factor (CF) of 41%. The LODES system 304 may have a power rating (capacity) of 97 MW, a rated duration (energy/power ratio) of 50 h and an energy rating of 4,850 MWh. In another such example, the wind farm 302 may have a peak generation output (capacity) of 315 MW and a capacity factor (CF) of 41%. The LODES system 304 may have a power rating (capacity) of 110 MW, a rated duration (energy/power ratio) of 25 h and an energy rating of 2,750 MWh.

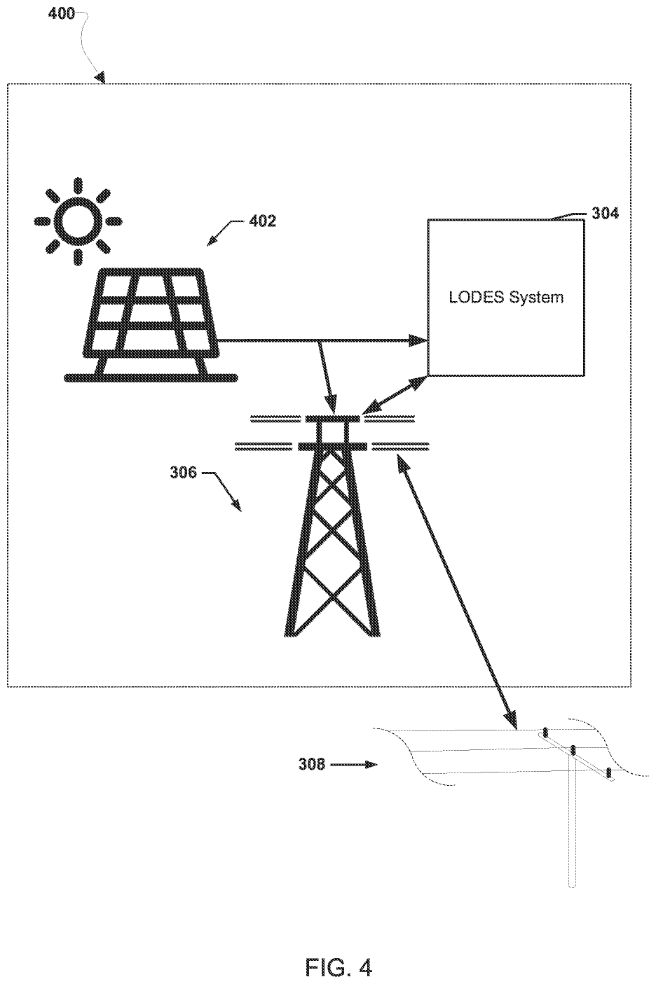

FIG. 4 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The system of FIG. 4 may be similar to the system of FIG. 3, except a photovoltaic (PV) farm 402 may be substituted for the wind farm 302. The LODES system 304 may be electrically connected to the PV farm 402 and one or more transmission facilities 306. The PV farm 402 may be electrically connected to the transmission facilities 306. The transmission facilities 306 may be electrically connected to the grid 308. The PV farm 402 may generate power and the PV farm 402 may output generated power to the LODES system 304 and/or the transmission facilities 306. The LODES system 304 may store power received from the PV farm 402 and/or the transmission facilities 306. The LODES system 304 may output stored power to the transmission facilities 306. The transmission facilities 306 may output power received from one or both of the PV farm 402 and LODES system 304 to the grid 308 and/or may receive power from the grid 308 and output that power to the LODES system 304. Together the PV farm 402, the LODES system 304, and the transmission facilities 306 may constitute a power plant 400 that may be a combined power generation, transmission, and storage system. The power generated by the PV farm 402 may be directly fed to the grid 308 through the transmission facilities 306, or may be first stored in the LODES system 304. In certain cases the power supplied to the grid 308 may come entirely from the PV farm 402, entirely from the LODES system 304, or from a combination of the PV farm 402 and the LODES system 304. The dispatch of power from the combined PV farm 402 and LODES system 304 power plant 400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 400, the LODES system 304 may be used to reshape and “firm” the power produced by the PV farm 402. In one such example, the PV farm 402 may have a peak generation output (capacity) of 490 MW and a capacity factor (CF) of 24%. The LODES system 304 may have a power rating (capacity) of 340 MW, a rated duration (energy/power ratio) of 150 h and an energy rating of 51,000 MWh. In another such example, the PV farm 402 may have a peak generation output (capacity) of 680 MW and a capacity factor (CF) of 24%. The LODES system 304 may have a power rating (capacity) of 410 MW, a rated duration (energy/power ratio) of 200 h, and an energy rating of 82,000 MWh. In another such example, the PV farm 402 may have a peak generation output (capacity) of 330 MW and a capacity factor (CF) of 31%. The LODES system 304 may have a power rating (capacity) of 215 MW, a rated duration (energy/power ratio) of 150 h, and an energy rating of 32,250 MWh. In another such example, the PV farm 402 may have a peak generation output (capacity) of 510 MW and a capacity factor (CF) of 24%. The LODES system 304 may have a power rating (capacity) of 380 MW, a rated duration (energy/power ratio) of 50 h, and an energy rating of 19,000 MWh. In another such example, the PV farm 402 may have a peak generation output (capacity) of 630 MW and a capacity factor (CF) of 24%. The LODES system 304 may have a power rating (capacity) of 380 MW, a rated duration (energy/power ratio) of 25 h, and an energy rating of 9,500 MWh.

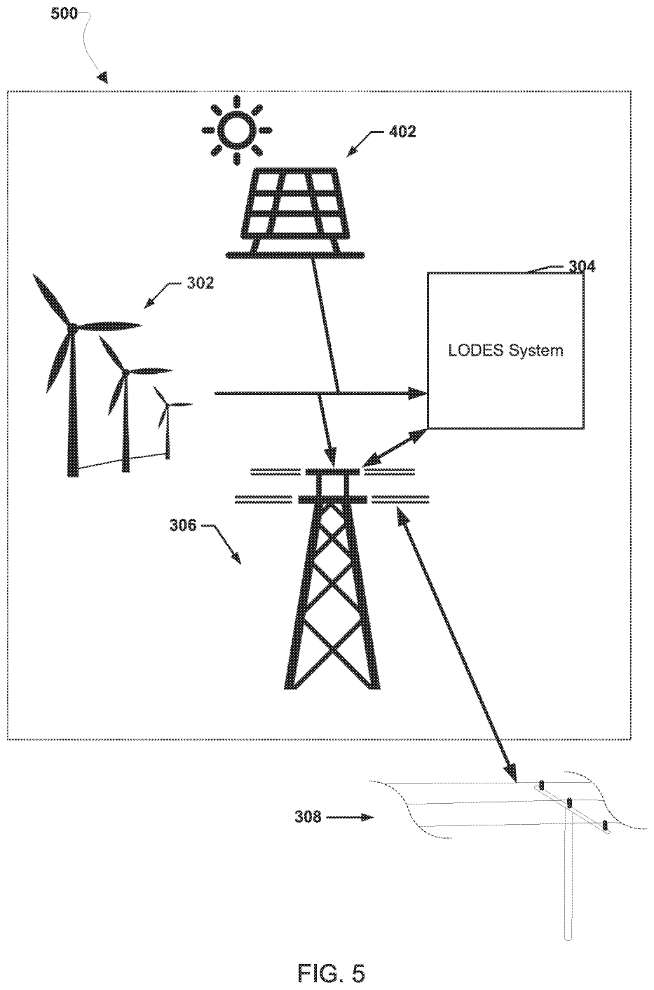

FIG. 5 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The system of FIG. 5 may be similar to the systems of FIGS. 3 and 4, except the wind farm 302 and the photovoltaic (PV) farm 402 may both be power generators working together in the power plant 500. Together the PV farm 402, wind farm 302, the LODES system 304, and the transmission facilities 306 may constitute the power plant 500 that may be a combined power generation, transmission, and storage system. The power generated by the PV farm 402 and/or the wind farm 302 may be directly fed to the grid 308 through the transmission facilities 306, or may be first stored in the LODES system 304. In certain cases the power supplied to the grid 308 may come entirely from the PV farm 402, entirely from the wind farm 302, entirely from the LODES system 304, or from a combination of the PV farm 402, the wind farm 302, and the LODES system 304. The dispatch of power from the combined wind farm 302, PV farm 402, and LODES system 304 power plant 500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 500, the LODES system 304 may be used to reshape and “firm” the power produced by the wind farm 302 and the PV farm 402. In one such example, the wind farm 302 may have a peak generation output (capacity) of 126 MW and a capacity factor (CF) of 41% and the PV farm 402 may have a peak generation output (capacity) of 126 MW and a capacity factor (CF) of 24%. The LODES system 304 may have a power rating (capacity) of 63 MW, a rated duration (energy/power ratio) of 150 h, and an energy rating of 9,450 MWh. In another such example, the wind farm 302 may have a peak generation output (capacity) of 170 MW and a capacity factor (CF) of 41% and the PV farm 402 may have a peak generation output (capacity) of 110 MW and a capacity factor (CF) of 24%. The LODES system 304 may have a power rating (capacity) of 57 MW, a rated duration (energy/power ratio) of 200 h, and an energy rating of 11,400 MWh. In another such example, the wind farm 302 may have a peak generation output (capacity) of 105 MW and a capacity factor (CF) of 51% and the PV farm 402 may have a peak generation output (capacity) of 70 MW and a capacity factor (CF) of 31 The LODES system 304 may have a power rating (capacity) of 61 MW, a rated duration (energy/power ratio) of 150 h, and an energy rating of 9,150 MWh. In another such example, the wind farm 302 may have a peak generation output (capacity) of 135 MW and a capacity factor (CF) of 41% and the PV farm 402 may have a peak generation output (capacity) of 90 MW and a capacity factor (CF) of 24%. The LODES system 304 may have a power rating (capacity) of 68 MW, a rated duration (energy/power ratio) of 50 h, and an energy rating of 3,400 MWh. In another such example, the wind farm 302 may have a peak generation output (capacity) of 144 MW and a capacity factor (CF) of 41% and the PV farm 402 may have a peak generation output (capacity) of 96 MW and a capacity factor (CF) of 24%. The LODES system 304 may have a power rating (capacity) of 72 MW, a rated duration (energy/power ratio) of 25 h, and an energy rating of 1,800 MWh.

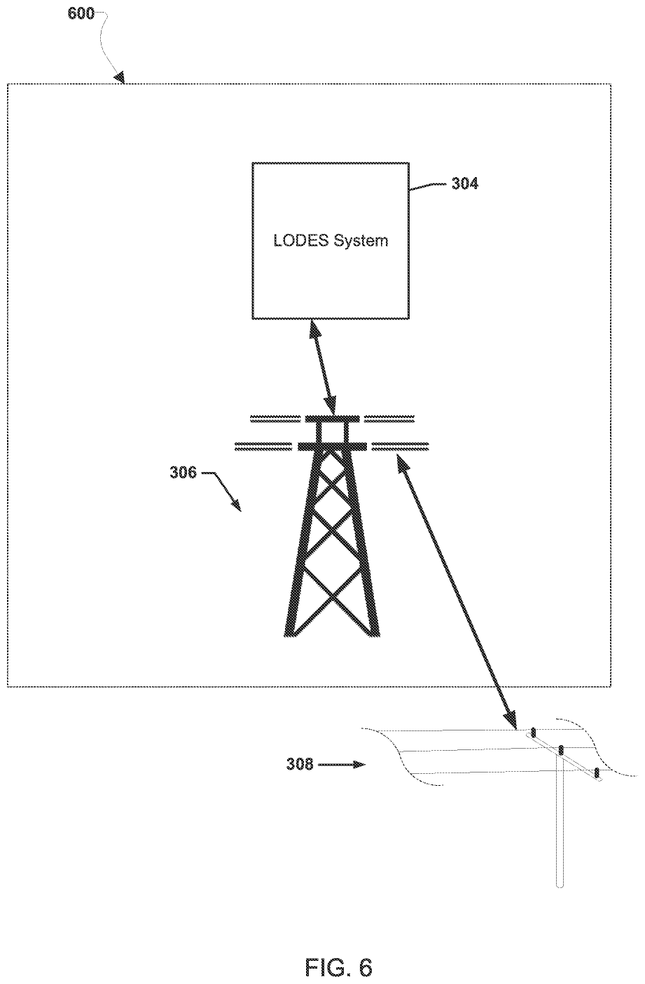

FIG. 6 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to one or more transmission facilities 306. In this manner, the LODES system 304 may operate in a “stand-alone” manner to arbiter energy around market prices and/or to avoid transmission constraints. The LODES system 304 may be electrically connected to one or more transmission facilities 306. The transmission facilities 306 may be electrically connected to the grid 308. The LODES system 304 may store power received from the transmission facilities 306. The LODES system 304 may output stored power to the transmission facilities 306. The transmission facilities 306 may output power received from the LODES system 304 to the grid 308 and/or may receive power from the grid 308 and output that power to the LODES system 304.

Together the LODES system 304 and the transmission facilities 306 may constitute a power plant 900. As an example, the power plant 900 may be situated downstream of a transmission constraint, close to electrical consumption. In such an example downstream situated power plant 600, the LODES system 304 may have a duration of 24 h to 500 h and may undergo one or more full discharges a year to support peak electrical consumptions at times when the transmission capacity is not sufficient to serve customers. Additionally in such an example downstream situated power plant 600, the LODES system 304 may undergo several shallow discharges (daily or at higher frequency) to arbiter the difference between nighttime and daytime electricity prices and reduce the overall cost of electrical service to customer. As a further example, the power plant 600 may be situated upstream of a transmission constraint, close to electrical generation. In such an example upstream situated power plant 600, the LODES system 304 may have a duration of 24 h to 500 h and may undergo one or more full charges a year to absorb excess generation at times when the transmission capacity is not sufficient to distribute the electricity to customers. Additionally in such an example upstream situated power plant 600, the LODES system 304 may undergo several shallow charges and discharges (daily or at higher frequency) to arbiter the difference between nighttime and daytime electricity prices and maximize the value of the output of the generation facilities.

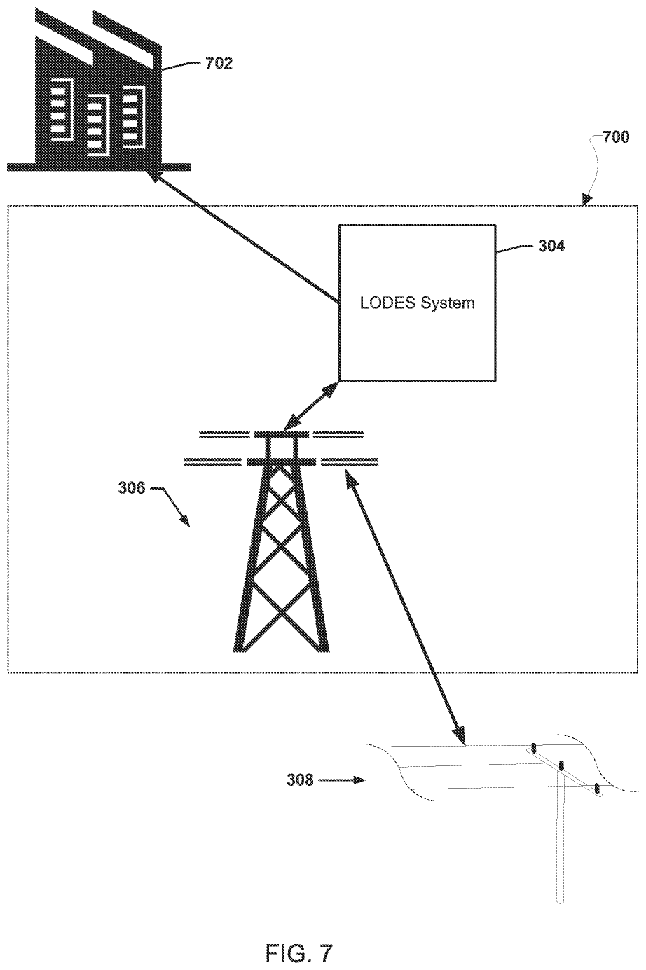

FIG. 7 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a commercial and industrial (C&I) customer 702, such as a data center, factory, etc. The LODES system 304 may be electrically connected to one or more transmission facilities 306. The transmission facilities 306 may be electrically connected to the grid 308. The transmission facilities 306 may receive power from the grid 308 and output that power to the LODES system 304. The LODES system 304 may store power received from the transmission facilities 306. The LODES system 304 may output stored power to the C&I customer 702. In this manner, the LODES system 304 may operate to reshape electricity purchased from the grid 308 to match the consumption pattern of the C&I customer 702.

Together, the LODES system 304 and transmission facilities 306 may constitute a power plant 700. As an example, the power plant 700 may be situated close to electrical consumption, i.e., close to the C&I customer 702, such as between the grid 308 and the C&I customer 702. In such an example, the LODES system 304 may have a duration of 24 h to 500 h and may buy electricity from the markets and thereby charge the LODES system 304 at times when the electricity is cheaper. The LODES system 304 may then discharge to provide the C&I customer 702 with electricity at times when the market price is expensive, therefore offsetting the market purchases of the C&I customer 702. As an alternative configuration, rather than being situated between the grid 308 and the C&I customer 702, the power plant 700 may be situated between a renewable source, such as a PV farm, wind farm, etc., and the transmission facilities 306 may connect to the renewable source. In such an alternative example, the LODES system 304 may have a duration of 24 h to 500 h, and the LODES system 304 may charge at times when renewable output may be available. The LODES system 304 may then discharge to provide the C&I customer 702 with renewable generated electricity so as to cover a portion, or the entirety, of the C&I customer 702 electricity needs.

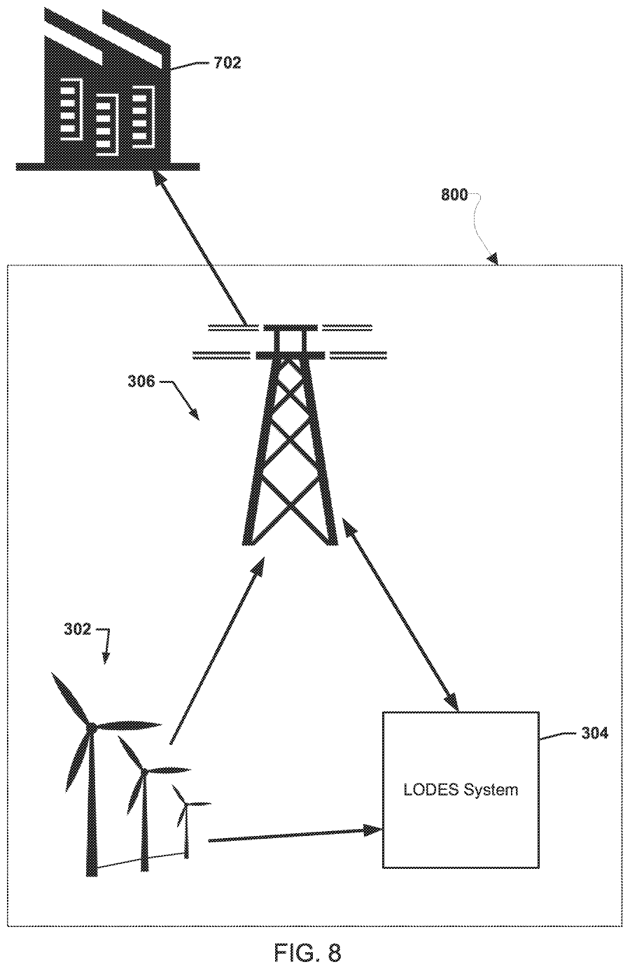

FIG. 8 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to a C&I customer 702. The wind farm 302 may generate power and the wind farm 302 may output generated power to the LODES system 304 and/or the transmission facilities 306. The LODES system 304 may store power received from the wind farm 302.

The LODES system 304 may output stored power to the transmission facilities 306. The transmission facilities 306 may output power received from one or both of the wind farm 302 and LODES system 304 to the C&I customer 702. Together the wind farm 302, the LODES system 304, and the transmission facilities 306 may constitute a power plant 800 that may be a combined power generation, transmission, and storage system. The power generated by the wind farm 302 may be directly fed to the C&I customer 702 through the transmission facilities 306, or may be first stored in the LODES system 304. In certain cases, the power supplied to the C&I customer 702 may come entirely from the wind farm 302, entirely from the LODES system 304, or from a combination of the wind farm 302 and the LODES system 304. The LODES system 304 may be used to reshape the electricity generated by the wind farm 302 to match the consumption pattern of the C&I customer 702. In one such example, the LODES system 304 may have a duration of 24 h to 500 h and may charge when renewable generation by the wind farm 302 exceeds the C&I customer 702 load. The LODES system 304 may then discharge when renewable generation by the wind farm 302 falls short of C&I customer 702 load so as to provide the C&I customer 702 with a firm renewable profile that offsets a fraction, or all of, the C&I customer 702 electrical consumption.

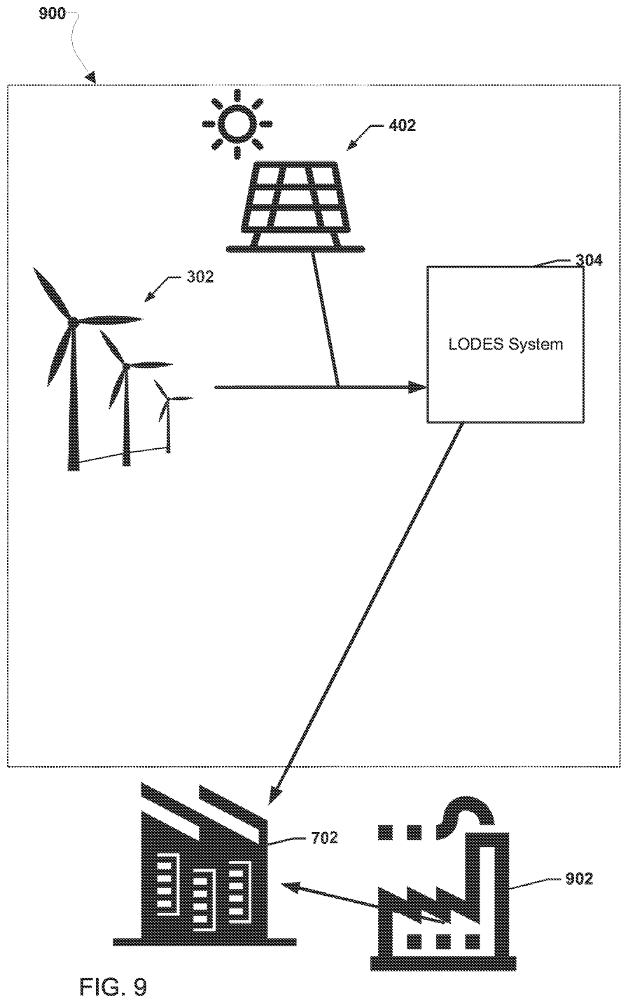

FIG. 9 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be part of a power plant 900 that is used to integrate large amounts of renewable generation in microgrids and harmonize the output of renewable generation by, for example a PV farm 402 and wind farm 302, with existing thermal generation by, for example a thermal power plant 902 (e.g., a gas plant, a coal plant, a diesel generator set, etc., or a combination of thermal generation methods), while renewable generation and thermal generation supply the C&I customer 702 load at high availability. Microgrids, such as the microgrid constituted by the power plant 900 and the thermal power plant 902, may provide availability that is 90% or higher. The power generated by the PV farm 402 and/or the wind farm 302 may be directly fed to the C&I customer 702, or may be first stored in the LODES system 304.

In certain cases the power supplied to the C&I customer 702 may come entirely from the PV farm 402, entirely from the wind farm 302, entirely from the LODES system 304, entirely from the thermal power plant 902, or from any combination of the PV farm 402, the wind farm 302, the LODES system 304, and/or the thermal power plant 902. As examples, the LODES system 304 of the power plant 900 may have a duration of 24 h to 500 h. As a specific example, the C&I customer 702 load may have a peak of 100 MW, the LODES system 304 may have a power rating of 14 MW and duration of 150 h, natural gas may cost S6/million British thermal units (MMBTU), and the renewable penetration may be 58%. As another specific example, the C&I customer 702 load may have a peak of 100 MW, the LODES system 304 may have a power rating of 25 MW and duration of 150 h, natural gas may cost S8/MMBTU, and the renewable penetration may be 65%.

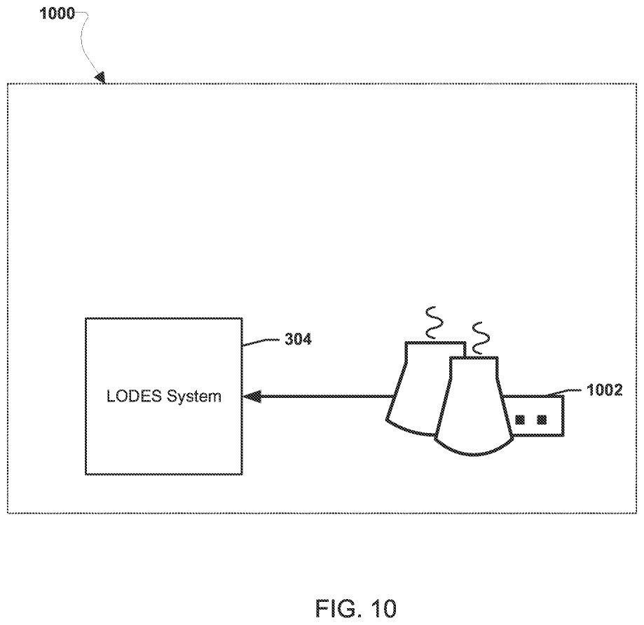

FIG. 10 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be used to augment a nuclear plant 1002 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1000 constituted by the combined LODES system 304 and nuclear plant 1002. The nuclear plant 1002 may operate at high capacity factor and at the highest efficiency point, while the LODES system 304 may charge and discharge to effectively reshape the output of the nuclear plant 1002 to match a customer electrical consumption and/or a market price of electricity. As examples, the LODES system 304 of the power plant 1000 may have a duration of 24 h to 500 h. In one specific example, the nuclear plant 1002 may have 1,000 MW of rated output and the nuclear plant 1002 may be forced into prolonged periods of minimum stable generation or even shutdowns because of depressed market pricing of electricity. The LODES system 304 may avoid facility shutdowns and charge at times of depressed market pricing; and the LODES system 304 may subsequently discharge and boost total output generation at times of inflated market pricing.

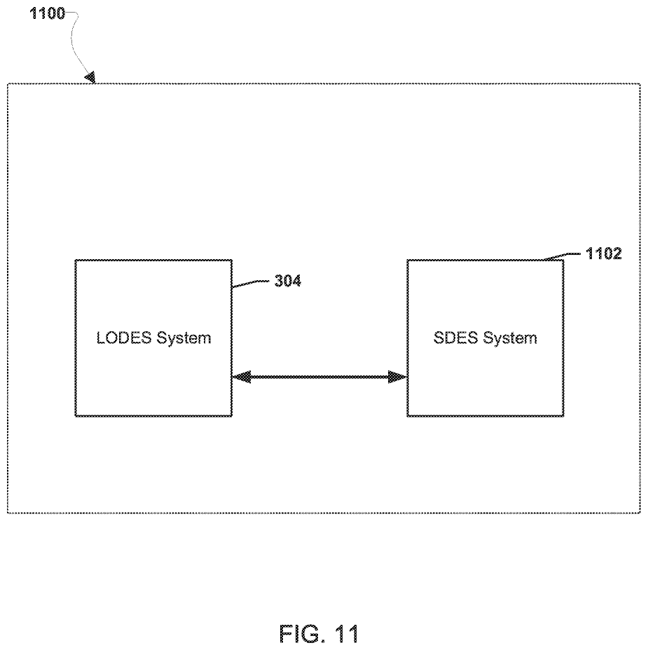

FIG. 11 illustrates an example system in which one or more aspects of the various embodiments may be used as part of bulk energy storage system. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may operate in tandem with a SDES system 1102. Together the LODES system 304 and SDES system 1102 may constitute a power plant 1100. As an example, the LODES system 304 and SDES system 1102 may be co-optimized whereby the LODES system 304 may provide various services, including long-duration back-up and/or bridging through multi-day fluctuations (e.g., multi-day fluctuations in market pricing, renewable generation, electrical consumption, etc.), and the SDES system 1102 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1102 may have durations of less than 10 hours and round-trip efficiencies of greater than 80%. The LODES system 304 may have durations of 24 h to 500 h and round-trip efficiencies of greater than 40%. In one such example, the LODES system 304 may have a duration of 150 hours and support customer electrical consumption for up to a week of renewable under-generation. The LODES system 304 may also support customer electrical consumption during intra-day under-generation events, augmenting the capabilities of the SDES system 1102. Further, the SDES system 1102 may supply customers during intra-day under-generation events and provide power conditioning and quality services such as voltage control and frequency regulation.

Various examples are provided below to illustrate aspects of the various embodiments. Example 1: A battery, comprising: a positive electrode; an electrolyte; and a negative electrode, wherein the negative electrode comprises a porous metal. Example 2. The battery of example 1, wherein the porous metal was fabricated at least in part using at least one fugitive pore former. Example 3. The battery of any of examples 1-2, wherein the porous metal comprises iron. Example 4. The battery of any of examples 2-3, wherein the fugitive pore former is a reducing agent. Example 5. The battery of example 4, wherein the reducing agent comprises carbon. Example 6. The battery of any of examples 2-5, wherein the fugitive pore former comprises iron (II) sulfate, iron (II,II) sulfate, mackinawite, marcasite, pyrite, troilite, pyrrhotite, greigite, amorphous iron (II) sulfide, or lead sulfide. Example 7. The battery of any of examples 2-5, wherein the fugitive pore former comprises coal. Example 8. The battery of any of examples 1-7, wherein the porous metal is produced by reduction in a hearth furnace. Example 9. The battery of example 8, wherein the hearth furnace is a rotary hearth furnace or a linear hearth furnace. Example 10. The battery of any of examples 1-7, wherein the porous metal is produced by reduction in a rotary kiln. Example 11. The battery of any of examples 1-7, wherein formation of pores in the porous metal occurs by electrochemical reduction in the battery. Example 12. The battery of example 11, wherein the fugitive pore former comprises silica, sodium silicate, sodium oxide, calcium oxide, or magnesium oxide. Example 13. The battery of example 11, wherein the fugitive pore former comprises a salt of the electrolyte. Example 14. The battery of example 13, wherein the fugitive pore former comprises potassium or sodium hydroxide. Example 15. The battery of example 11, wherein the fugitive pore former comprises ammonium nitrate or potassium sulfate. Example 16. The battery of any of examples 2-15, wherein the porous metal is formed from a precursor material having a first size and the fugitive pore former particle size is about the same as the first size. Example 17. The battery of any of examples 2-15, wherein the porous metal has a layer of discharge product on its surface and the fugitive pore former particle size exceeds twice the thickness of the layer of discharge product. Example 18. The battery of any of examples 2-17, wherein the at least one fugitive pore former comprises at least two different fugitive pore formers. Example 19. The battery of example 18, wherein the two different fugitive pore formers are different type pore formers and/or different size pore formers. Example 20. The battery of any of examples 1-19, further comprising a current collector metallurgically bonded and/or in electrical communication with the negative electrode, the current collector along at least a portion of the negative electrode. Example 21. The battery of any of examples 1-19, wherein the positive electrode comprises an air-breathing cathode, a nickel oxyhydroxide electrode, or a manganese dioxide electrode. Example 22. The battery of any of examples 3-21, wherein the iron comprises steelmaking dust, mill scale, iron ore, iron mesh, iron wire, iron powder, or any combination thereof. Example 23. The battery of any of examples 2-22, wherein the fugitive pore former comprises coke. Example 24. The battery of any of examples 1-23, wherein the porous metal was fabricated at least in part using a pore former comprising a metal carbonate. Example 25. A method of forming a porous metal for a negative electrode of a battery, comprising using at least one fugitive pore former to form pores in the porous metal. Example 26. The method of example 25, wherein the fugitive pore former is the fugitive pore former of any of examples 3-24 and the pores are formed with a reduction step or without a reduction step. Example 27. A bulk energy storage system, comprising: one or more batteries of any of examples 1-24. Example 28. A long duration energy storage system configured to hold an electrical charge for at least 24 hours, the system comprising one or more batteries of any of examples 1-24.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Further, any step of any embodiment described herein can be used in any other embodiment. The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A battery, comprising:
a positive electrode;
an electrolyte; and
a negative electrode, wherein the negative electrode comprises a porous metal.

2. The battery of claim 1, wherein the porous metal was fabricated at least in part using at least one fugitive pore former.

3. The battery of claim 2, wherein the porous metal comprises iron.

4. The battery of claim 3, wherein the fugitive pore former is a reducing agent.

5. The battery of claim 4, wherein the reducing agent comprises carbon.

6. The battery of claim 2, wherein the fugitive pore former comprises iron (II) sulfate, iron (II,II) sulfate, mackinawite, marcasite, pyrite, troilite, pyrrhotite, greigite, amorphous iron (II) sulfide, or lead sulfide.

7. The battery of claim 2, wherein the fugitive pore former comprises coal.

8. The battery claim 1, wherein the porous metal is produced by reduction in a hearth furnace.

9. The battery claim 8, wherein the hearth furnace is a rotary hearth furnace or a linear hearth furnace.

10. The battery claim 1, wherein the porous metal is produced by reduction in a rotary kiln.

11. The battery claim 2, wherein formation of pores in the porous metal occurs by electrochemical reduction in the battery.

12. The battery of claim 11, wherein the fugitive pore former comprises silica, sodium silicate, sodium oxide, calcium oxide, or magnesium oxide.

13. The battery of claim 11, wherein the fugitive pore former comprises a salt of the electrolyte.

14. The battery of claim 13, wherein the fugitive pore former comprises potassium or sodium hydroxide.

15. The battery of claim 11, wherein the fugitive pore former comprises ammonium nitrate or potassium sulfate.

16. The battery claim 2, wherein the porous metal is formed from a precursor material having a first size and the fugitive pore former particle size is about the same as the first size.

17. The battery of claim 2, wherein the porous metal has a layer of discharge product on its surface and the fugitive pore former particle size exceeds twice the thickness of the layer of discharge product.

18. The battery of claim 2, wherein the at least one fugitive pore former comprises at least two different fugitive pore formers.

19. The battery of claim 18, wherein the two different fugitive pore formers are different type pore formers and/or different size pore formers.

20. The battery of claim 1, further comprising a current collector metallurgically bonded and/or in electrical communication with the negative electrode, the current collector along at least a portion of the negative electrode.

21. The battery of claim 1, wherein the positive electrode comprises an air-breathing cathode, a nickel oxyhydroxide electrode, or a manganese dioxide electrode.

22. The battery of claim 3, wherein the iron comprises steelmaking dust, mill scale, iron ore, iron mesh, iron wire, iron powder, or any combination thereof.

23. The battery of claim 2, wherein the fugitive pore former comprises coke.

24. The battery of claim 1, wherein the porous metal was fabricated at least in part using a pore former comprising a metal carbonate.

25-28. (canceled)
